(19) United States
(12) Patent Application Publication
(10) Pub. No.: US 2008/0089369 A1
(43) Pub. Date: Apr. 17, 2008

(54) INJECTION SEEDING EMPLOYING CONTINUOUS WAVELENGTH SWEEPING FOR MASTER-SLAVE RESONANCE

(75) Inventors: Ningyi Luo, Fremont, CA (US); Sheng-Bai Zhu, Fremont, CA (US)

Correspondence Address: PAVILION INTEGRATION CORPORATION, 2380 QUME DRIVE, SUITE G, SAN JOSE, CA, 95131, US

(73) Assignee: Pavilion Integration Corporation, Fremont, CA (US)

(21) Appl. No.: 11/549,696

(22) Filed: Oct. 16, 2006

(51) Int. Cl. H01S 3/10

(52) U.S. Cl. 372/28

(57) ABSTRACT

A method for effective injection seeding is based on continuous wavelength sweeping for matching the injected seeds with one or more longitudinal mode(s) of the slave oscillator in every pulse. This is achieved through rapidly varying laser drive current, as a result of RF modulation. Depending on the modulation parameters, the seeder may be operated in CW or quasi-CW or pulsed mode, with a narrow or broad bandwidth, for injection seeding of single longitudinal mode or multimode. The wavelength and bandwidth of the laser output can be tuned according to the needs. Injection seeding of high repetition rates is achievable. From pulse to pulse, the master-slave resonance persists though may occur at different longitudinal modes upon cavity length fluctuations. Cavity length control and phase locking schemes are consequently not required. The present invention also encompasses an injection seeding laser system, which is constructed in accordance with the inventive method, and a novel application of RF modulated laser diode to spectrum/wavelength control and to producing high power Gaussian beam with narrow pulse width in a stable, reliable, and cost-effective manner.

### CROSS REFERENCE TO RELATED APPLICATION

This is a continuation-in-part of United States Patent Publication No. 20060215714, filed Jun. 29, 2005, entitled “Injection Seeding Employing Continuous Wavelength Sweeping for Master-Slave Resonance” and is hereby incorporated by reference in its entirety.

### FIELD OF THE INVENTION

This invention relates in general to injection seeding of slave by master, in particular to laser injection seeding employing continuous wavelength sweeping for master-slave resonance, and more particularly, to replacement of stringent control of slave cavity length and phase locking between the injected and the output signals with continuous wavelength sweeping accomplished through a radio frequency (RF) modulated seed laser drive current for effective injection seeding.

### BACKGROUND OF THE INVENTION

Many applications require compact coherent sources of radiation with stable output, controlled wavelength and/or confined spectrum bandwidth, short pulse width, TEM₀₀ beam, and improved slope efficiencies. Injection seeding is a technology commonly employed to fulfill such requirements. By controlling the spectral properties of a power oscillator, referred to as slave, with an external low power output laser, referred to as seeder (or master), optical properties such as wavelength selection and control, spectrum bandwidth, beam quality, output power stability and optical pulse-to-pulse jitter, as well as system efficiency and reliability, can be improved, while practical problems associated with high power lasers can be eliminated or reduced. These problems include nonuniform pump profiles, thermally induced optical distortions, in particular, laser beam quality degradation due to thermal lensing, and degradation or damage of optical components and optical materials such as lasing gain media, nonlinear optical crystals, and dielectric films. Injection seeding can also improve laser output power stability and reduce laser pulse to pulse jitter.

Single longitudinal mode (SLM) injection seeding has long been demonstrated as an effective approach to generating narrow linewidth of high power radiation and, in particular, to ensuring single transverse and longitudinal mode of either gain-switched or Q-switched operation. With injection seeding, lasing will occur only in the desired longitudinal mode because the buildup time from the seed beam is much faster than any other unseeded modes that must build up from random noise photons. Conventionally, the cavity length of the slave oscillator must be actively controlled to resonate at the injected frequency within the tolerance.

In conventional SLM injection seeding, a diode pumped solid-state (DPSS) ring laser or an external cavity diode laser or a fiber laser is frequently employed as a seeder. SLM seeders can be operated in pulsed or CW mode. CW seeding is most commonly used because it eliminates the needs for timing between the seeder and the pumping process. SLM seed sources may have a linear oscillator comprised of two opposing plane-parallel or curved mirrors at right angles to the axis of the active material or a ring oscillator. Ring lasers have the beam circulating in a loop, which eliminates problems such as spatial hole burning caused by the standing-wave distribution of the intensity. Linear SLM lasers are normally based on short cavities to increase intermode spacing and require careful control of the cavity length and/or use of intracavity or extracavity etalons or gratings or other wavelength selective elements to filter out a desired single mode seed beam from the tunable range of the oscillator. Continuous tunability often relies on feedback control of the seeder cavity length, the crystal angles, and tuning mirrors covering a broad range of wavelengths. They are complicated and are limited to a small number of wavelengths. In addition, the seeds thus generated are generally too weak to produce high power single mode outputs.

Alternatively, high power single longitudinal mode outputs can be produced on the basis of multimode injection seeding. In U.S. Pat. No. 6,016,323, Kafka, et al. claimed a short cavity resonator, which produced a broadly tunable single longitudinal mode output from a multimode seed source. Multimode seeders do not require cavity length control, however, the seeding may not be stable and the slave laser may suffer from mode hopping.

While some applications prefer laser emission on a single longitudinal mode, there exist other applications for which high optical quality beams, short temporal coherence length, high power output, and stable operation of multiple modes are desirable. Examples include laser optical scanning systems, optical memory devices, laser raster printing systems, laser display systems, inspection systems, lithographic systems, imaging instrumentation, and other applications where speckle reduction is necessary. In U.S. Pat. No. 5,974,060, Byren, et al. demonstrated a laser oscillator for simultaneously producing a number of widely separated longitudinal modes from a short cavity seeder. The optical length of the slave resonator cavity was adjusted to be an integer multiple of the optical length of the master laser cavity.

A basic requirement for effective injection seeding is that resonance between the slave modes and the photons from the master must be kept in every pulse. Conventionally, the master-slave resonance is based on stabilized mode frequency of the seed laser (master), active control of the resonance wavelength or longitudinal modes of the seeded laser (slave), and locked phase angle between the injected and output signals.

One way to stabilize seed laser wavelength was disclosed in U.S. Pat. No. 4,583,228, wherein the drive current and the laser temperature were controlled by feedback signals derived from an external Fabry-Perot interferometer. Alternatively, the wavelength reference can be located within the oscillator, as described in U.S. Pat. No. 6,930,822. Wavelength stabilization can also be accomplished by movement of an optical element, e.g., rotation of a prism inside the laser, together with a signal processor. An example of such systems is given in U.S. Pat. No. 6,393,037. Other means of wavelength stabilization includes adjusting the temperature or angular tilt or spacing of an intracavity etalon; or adjusting the angle of a prism, a grating, a mirror, or a birefringent filter; or adjustment of the cavity length.

In the prior art, injection seeding relies on active control of the slave cavity to be kept in resonance with the photons emitted from the master laser. One of the standard methods to achieve this goal is cavity dithering. According to this technique, the cavity length is dithered across a resonance and is stabilized by monitoring the transmission of the cavity and hence generating an error signal, which is used as the feedback to a piezoelectric translator (PZT) mounted on one of the cavity mirrors. A practical implementation of such systems can be found in, e.g., Applied Optics 35 pp. 1999-2004 (1996).

In a Q-switched injection seeding laser operation, the trig time can be controlled to occur only when the interference of the seed light and the light that leaks out from a slave cavity mirror shows a maximum. This technique guarantees that Q-switch is trigged only when the slave cavity is in resonance with the seed laser. Pioneered by Fry and his coworkers, this technique has a disadvantage, namely, the laser could fire at any time during the voltage ramp, consequently, synchronization with other events might be impossible.

This problem can be overcome by trigging the Q-switch at a predefined time after the start of the ramp. Once the master-slave resonance is detected, the ramp is stopped and the length of the slave cavity is held constant until reaching the predefined time for trigging the Q-switch. This method guarantees that laser shot occurs at a fixed time. However, due to the need to hold the ramp, ramping times have to be reduced in order to avoid mechanical ringing in the system. An application of the ramp-hold-fire seeding technique to a Ti:sapphire laser is described in Applied Optics 40, pp. 3046-3050 (2001).

An alternative method for master-slave resonance is based on minimizing the build-up time of the laser radiation. Many commercial Nd:YAG systems use this technique. An obvious problem of this technique is that the direction of deviation from the optimum cavity length is not measurable and the feedback occurs in a random fashion. In practice, this technique only works reliably for a predefined and carefully optimized repetition rate, between 10 Hz and 100 Hz. Refer to, e.g., Applied Optics 25 pp. 629-633 (1986).

All of these techniques require complex and costly systems such as those employed for cavity length control and/or phase locking between the seed and seeded lasers. There is a need for novel scheme of master-slave resonance, as well as compact, robust, reliable, efficient, and low-cost laser sources capable of generating spectrum-purified, stable and short-duration pulses with high power output and low optical noise.

### SUMMARY OF THE INVENTION

It is therefore an object of the present invention to provide for a method and a light source that can be directly applied to injection seeding, wherein control of slave cavity length and phase locking between the injected and output signals are not required. Consequently, spectral purification and stabilization can be achieved cost-effectively and conveniently.

Viewed from a first aspect, our invention employs continuous wavelength sweeping for master-slave resonance. In particular, the injected photons repeatedly sweep over a range covering one or more longitudinal modes of the slave oscillator, which eliminates the needs for complicated cavity length control and phase locking.

Viewed from a second aspect, continuous wavelength sweeping is accomplished through periodic variation of the seed laser drive current, in particular, through a radio frequency (RF) modulated drive current that produces optical seeds in pulsed or quasi-CW or CW mode. Due to the high frequency modulation, wavelength sweeping is rapid and essentially continuous.

Viewed from a third aspect, the degree of RF modulation, repetition rate, and duty cycle can vary according to specific applications. At any instant, the seed beam is narrowband. As the drive current changes, the wavelength sweeps. From cycle to cycle, the central wavelength dithers. Depending on the degree of RF modulation, the time-averaged seed spectrum spans different bandwidth. Narrowband or SLM seeds can be produced from a laser diode operated in CW or quasi-CW mode. If the modulation is so deep that the drive current periodically passes through the threshold at an extremely high rate, each time the seed laser is extinguished and then rebuilds the oscillation in one or more randomly selected modes. When averaged over time, the injection seeding is broadband and multimode. Therefore, the present invention can be applied to injection seeded lasers for producing single longitudinal mode or multiple longitudinal mode outputs.

Viewed from a fourth aspect, the seed source can be an RF modulated laser diode or other light sources producing stable laser output with rapidly varying wavelength over a range covering one or more longitudinal modes of the slave oscillator.

Viewed from a fifth aspect, the slave gain medium can be solid-state, liquid (dye), or gas including excimer, and can be activated electrically or optically. The non-invasive master-slave resonance can be applied to injection seeding of standing-wave oscillators or traveling-wave oscillators with linear, folded or ring configurations.

Viewed from a sixth aspect, precise timing between the seeder and the pump pulse is not required in most cases. Since the seeder is driven by an RF modulated current, the injection seeding is CW or quasi-CW or pulsed at a repetition rate higher than the inverse of typical pump pulse durations.

Viewed from a seventh aspect, optical pump sources can be selected from the group including flash lamps, arc lamps, laser diodes, diode pumped solid-state lasers with or without wavelength conversion, light emitting diode (LED) arrays, vertical cavity surface emitting laser (VCSEL) arrays, and any other light sources with either end-pumping or side-pumping configuration.

Viewed from an eighth aspect, the injection seeding locked spectrum can be stabilized at a desired wavelength and the bandwidth can vary to meet the requirements and preference for various applications. A seeder operated in a single longitudinal mode allows of producing laser output with high coherence and well defined narrow spectral bandwidth. SLM injection seeding can be achieved and optimized through one-time adjustment for overlapping the time-averaged sweeping spectrum with the desired longitudinal mode of the slave oscillator. This process can be accomplished by, e.g., temperature and/or drive current tuning of the seed diode.

Viewed from a ninth aspect, the present invention enables laser output of good beam quality (Gaussian profile) and large beam size in an ordinary Fabry-Perot cavity including short cavities. Optical noise associated with mode hop, mode partitioning, and/or interference between coherent lights can be greatly reduced.

Viewed from a tenth aspect, the inventive master-slave resonance scheme eliminates the need for active cavity length control. This enables direct coating or mounting of the slave resonator mirrors onto the gain medium. Injection seeding of monolithic microchip slave laser with or without intracavity nonlinear optical processes such as frequency conversion and/or optical parametric generation thus becomes available. Our invention also makes injection seeding of fiber lasers possible.

The advantages and novel features of this invention will become more obvious from the detailed description below.

### BRIEF DESCRIPTION OF THE DRAWINGS

FIG. 1A is a block diagram of master-slave laser configuration according to the present invention;

FIG. 1B is a block diagram of master-slave laser configuration according to the prior art;

FIG. 2A is a graphic illustration of the inventive wavelength sweeping scheme for single longitudinal mode laser output;

FIG. 2B is a graphic illustration of the inventive wavelength sweeping scheme for multimode laser output;

FIG. 3A shows an RF modulation mechanism and drive current waveform;

FIG. 3B shows a drive current waveform and the produced seeder wavelength sweeping spectrum that spans multiple longitudinal modes of the slave oscillator;

FIG. 3C shows a drive current waveform and the produced seeder wavelength sweeping spectrum that covers a single longitudinal mode of the slave oscillator;

FIG. 4A shows the temperature dependence of the seeder wavelength sweeping spectrum in coordinate of the longitudinal modes of a slave oscillator;

FIG. 4B shows the DC-bias dependence of the seeder wavelength sweeping spectrum in coordinate of the longitudinal modes of a slave oscillator;

FIG. 5 displays waveforms of injected seeds, pump pulses, and laser output from a slave oscillator in time domain;

FIG. 6A is a schematic of an exemplary solid-state slave oscillator, which is controlled by a seed laser constructed in accordance with the present invention;

FIG. 6B is a schematic of another exemplary solid-state slave oscillator, which is controlled by a seed laser constructed in accordance with the present invention;

FIG. 6C is a schematic of another exemplary solid-state slave oscillator, which is controlled by a seed laser constructed in accordance with the present invention;

FIG. 6D displays the output spectrum of a solid-state slave oscillator, which is controlled by a seed laser constructed in accordance with the present invention. For comparison, the spectrum that is not controlled by the injection seeding is also displayed therein;

FIG. 7 is a schematic of an inventive injection-seeded solid-state laser that produces UV light;

FIG. 8 is a schematic of an injection-seeded solid-state laser with monolithic structure for intracavity wavelength conversion;

### DETAILED DESCRIPTION OF THE PRESENT INVENTION

As will be described in more detail hereafter, there is disclosed herein an injection seeding laser system employing continuous wavelength sweeping for non-invasive master-slave resonance.

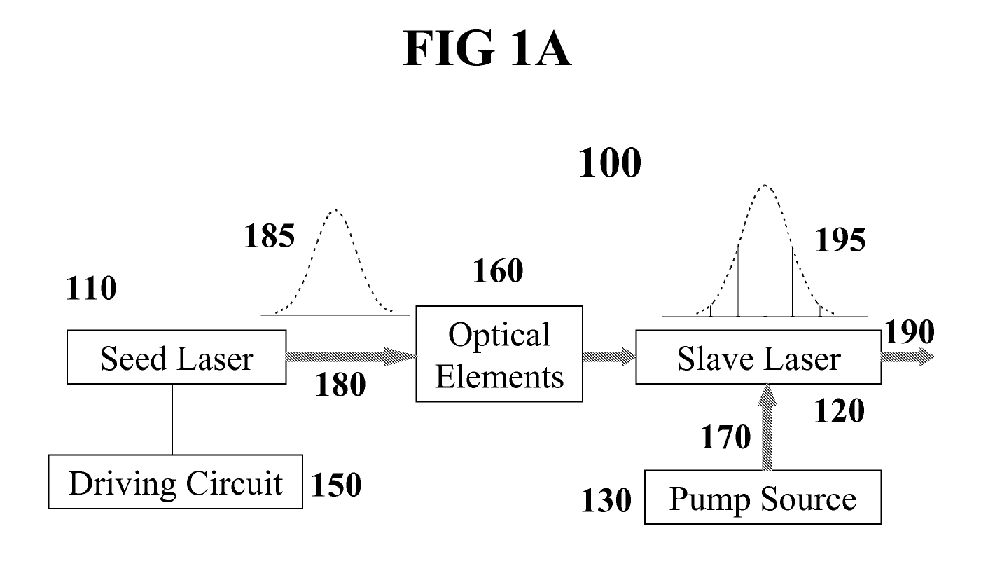

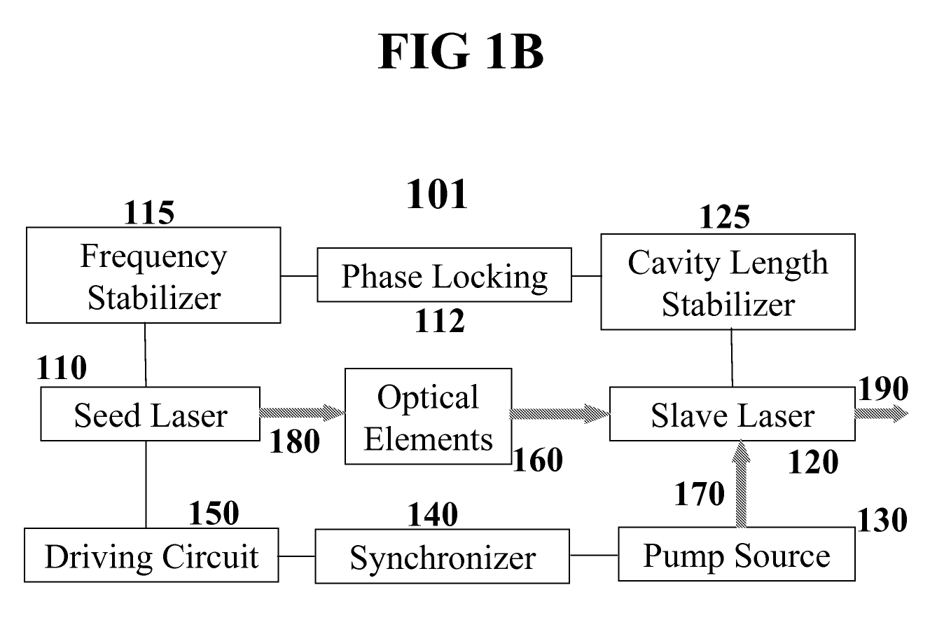

Referring to drawings and in particular to FIG. 1A, wherein a conceptual illustration of a master-slave laser constructed according to the present invention is given in form of block diagram. In particular, the master-slave laser system 100 is composed of a seed laser 110 as the master, a seeded laser 120 as the slave, and a pump source 130. In some applications, an optional timing synchronizer may be needed.

Advantageously, the seed laser 110 is a laser diode, which is energized by a driving circuit 150 with RF modulation. As the drive current varies, the wavelength of the light 180 emitted from the seed laser 110 changes, which results in a continuous wavelength sweeping spectrum 185. Through beam shaping optics 160, the light 180 is injected into the slave laser 120, as seeds. As can be appreciated by those skilled in the art, the seed laser is not restricted to laser diode. It can be other light sources producing continuous wavelength sweeping over a range covering one or more longitudinal modes of the slave laser.

On the other hand, the slave laser 120 is energized by pumping energy flow 170 so that population inversion is created. Generated by the pump source 130, the pumping energy flow 170 can be continuous or a series of pulses. For effective seeding, the seeds 180 should be injected into 120 on or before arrival of the pump pulses 170, although in some cases, the seeds may be introduced somewhat after the gain become positive. If the injection seeding beam 180 is CW or quasi-CW or pulsed at a high repetition rate and/or high duty cycle such that the interval between two successive seed pulses is shorter than the duration of the pump pulse, which activates the seeded laser, timing synchronization is not required. Otherwise, the seeding pulse frequency is preferably an integer multiple of the pump pulse frequency. As an advantage of the present invention, these conditions can be easily satisfied by appropriate selection of the operation parameters. Coupling between the seeder and the seeded laser can be free space or fiber optics.

The pump source 130 can be electrical or optical. For optical pumping, it can be flash lamps, arc lamps, laser diodes, diode pumped solid-state lasers with or without harmonic frequency conversion or frequency mixing, laser diode arrays, LED arrays or VCSEL arrays. Employing LED or VCSEL arrays as optical pump sources was described in United States Patent Application No. 20050201442, entitled “Solid-State Lasers Employing Incoherent Monochromatic Pump” and in U.S. patent application Ser. No. 11/414492, entitled “Vertical Cavity Surface Emitting Laser (VCSEL) Arrays Pumped Solid-State Lasers”. It should be pointed out that the pumping light 170 is not limited to pulses, it can also be continuous wave.

Advantageously, the seeded slave laser 120 can have a standing wave cavity or a traveling wave cavity with linear or folded or ring configuration and can be left as-is. There is no need for any structural modifications or adaptations. Still advantageously, the seeded slave laser 120 can be an ordinary optical oscillator or other devices such as optical parametric oscillator (OPO) or power amplifier or fiber laser/amplifier or Raman laser. It should also be pointed out that the gain medium of the seeded slave laser 120 can be solid-state, liquid (dye), or gas (low density) including excimer.

Depending on the number of longitudinal modes covered by the seed wavelength sweeping spectrum, the laser output 190 can be multimode or single mode. In addition, the purified spectrum 195 can be stabilized at a desired wavelength and the bandwidth can vary to meet the requirements and preference for various applications.

For comparison, the block diagram of a typical master-slave laser constructed according to the prior art is conceptually illustrated in FIG. 1B. In sharp contrast to the configuration shown in FIG. 1A, the seed laser 110 here is stabilized by a frequency stabilizer 115 and cavity length of the seeded (slave) laser 120 is stabilized by a cavity length stabilizer 125. Moreover, a phase locking 112 to lock the phase between the seeder and the seeded laser and a timing synchronizer 140 to control the trigging time of the pump pulse are necessary. These make the injection-seeding system very complicated and expensive, which dramatically limit its applications.

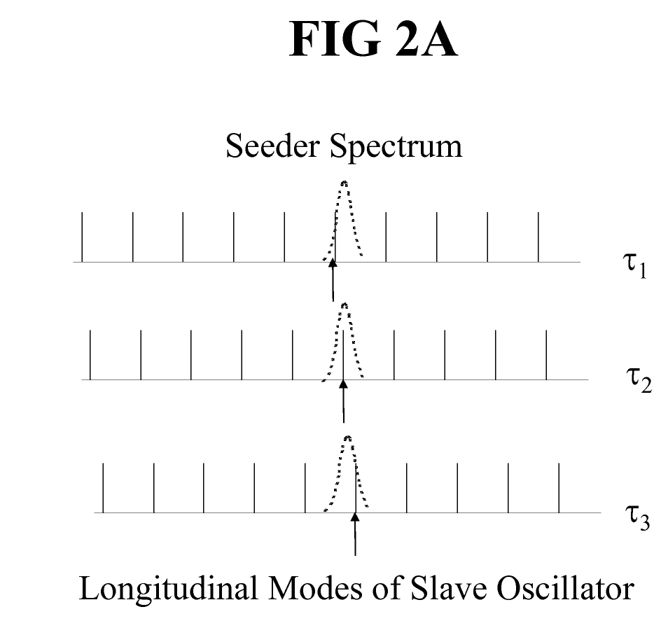

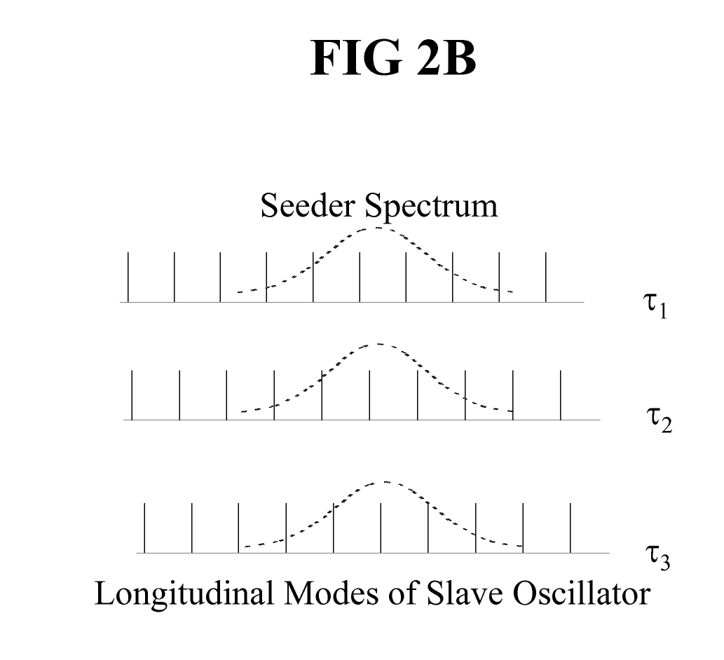

Returning now to our inventive teachings and, in particular, to FIGS. 2A and 2B, wherein the mechanism of master-slave resonance, which is non-invasive and is realized by intentional variation of the seed wavelength rather than active control of the slave laser cavity mode(s), is conceptually illustrated. In sharp contrast to the prior art employing complex cavity length stabilization or feedback control and phase locking schemes, the present invention provides a simple solution for master-slave resonance, according to which, the slave is a free-running oscillator or other devices without any modifications or adaptations. Although the optical length of the slave oscillator fluctuates all the time, the desired one (FIG. 2A) or more (FIG. 2B) longitudinal modes of the slave laser can always be precisely matched by the wavelength of the injected photons, which is continuously swept over a predefined range.

Conventional wavelength swept lasers employ wavelength tuning elements to make discrete change of laser output wavelength from a broadband laser gain. These lasers are prone to mode-hop. In some other conventional wavelength swept lasers such as wavelength-swept fiber lasers, the resonant cavities contain a narrowband filter or a tunable spectral filter, which can be an acousto-optic device, and a frequency shifter to provide continuous wavelength tuning. Frequency-shifted fiber lasers intrinsically favor pulsed rather than continuous wave operation. In addition, the laser systems are complicated and the wavelength sweeping rates are generally low. These limitations make them unavailable in applications such as injection seeding.

In sharp contrast to the prior art, the present invention accomplishes wavelength sweeping based on periodical variations of the laser drive current. At any instant in time, the seed beam spectrum is characterized as narrowband. As the drive current oscillates at an RF rate, the laser output wavelength experiences continuous change. Each RF cycle corresponds to a wavelength sweeping, normally covering a narrow bandwidth, and the central wavelength dithers from one cycle to another. Averaged over time, the bandwidth is broadened.

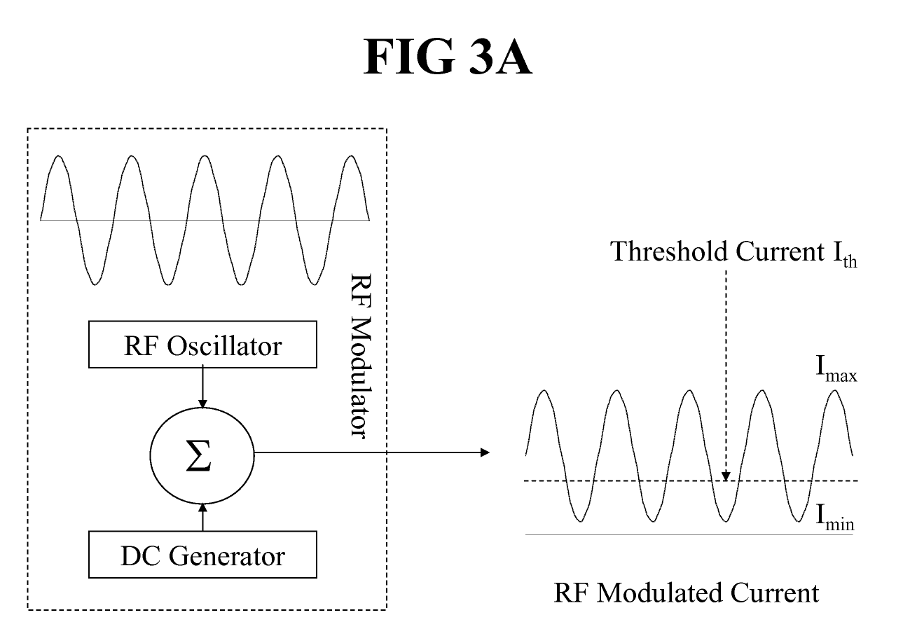

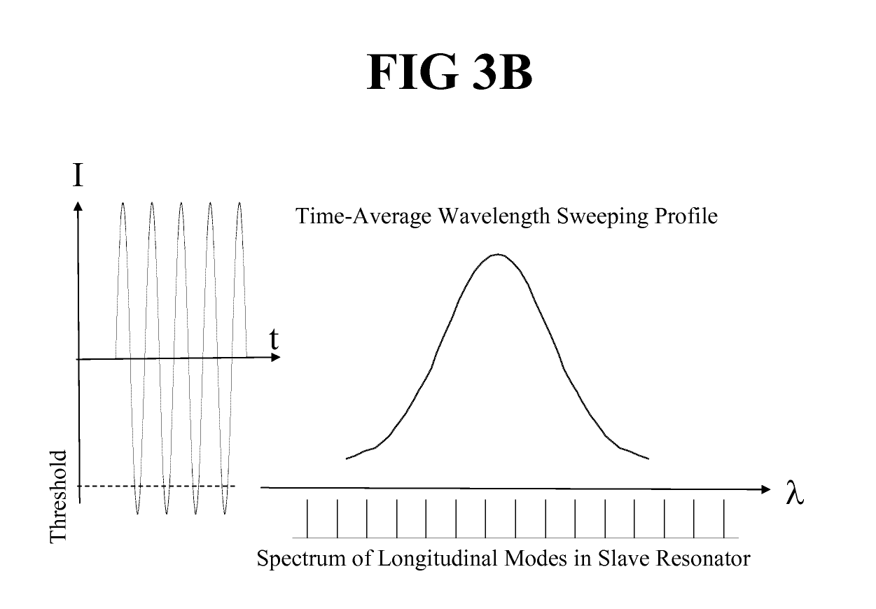

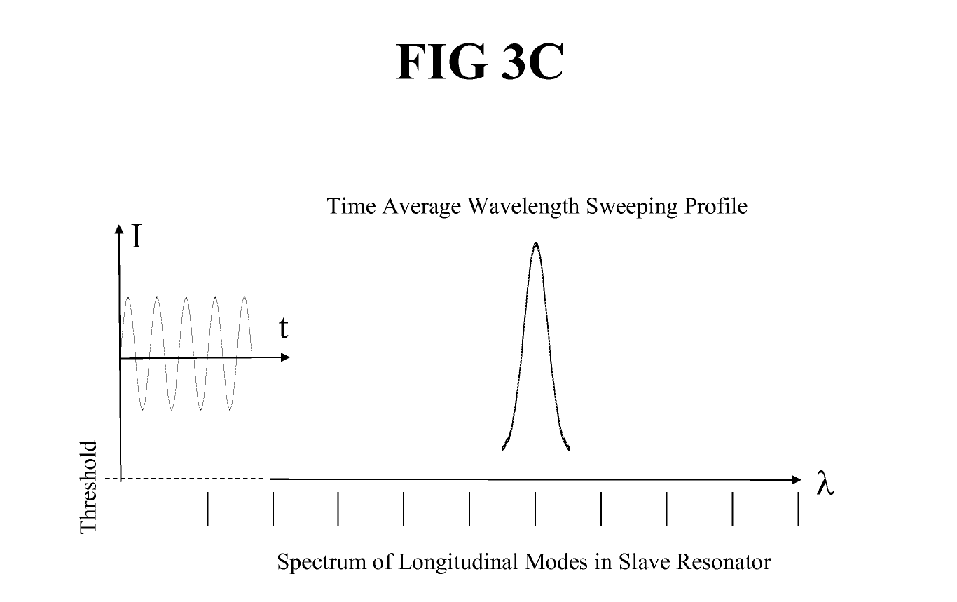

A schematic illustration of RF modulation mechanism is given in FIG. 3A. As shown in this graph, the RF modulator comprises a DC generator and an RF oscillator. Superimposition of the RF signal to the DC bias results in the drive current. Although the waveform shown in FIG. 3A is a sine function, it can be other periodic functions, preferably though not necessarily, linear or quasi-linear piecewise for relatively uniform sweeping. RF modulation has been applied to stabilization of laser diode operation and noise reduction. The present invention claims a new application, in particular, an application for cost-effective and convenient injection seeding, whether multimode or single mode, with broad or narrow bandwidth.

Parameters for RF modulation include frequency, duty cycle, linearity, and depth. The depth or degree of modulation can be defined as M_{d}=(Iₜₕ−Iₘᵢₙ)/(Iₘₐₓ−Iₘᵢₙ), where Iₜₕ denotes the threshold current, Iₘₐₓ and Iₘᵢₙ are, respectively, the maximum and minimum values of the drive current. We use this non-conventional definition because the drive current waveform may be non-sine and even asymmetric. For negative M_{d}, i.e., Iₜₕ<Iₘᵢₙ, the seeder operates in CW or quasi-CW mode and emits light all the time. As M_{d} becomes positive, the seeder generates a package of photons in pulsed mode and, due to repeated on-off operation, the laser oscillation restarts each cycle with randomly selected modes. The seed pulse width depends on the degree of modulation, frequency, and duty cycle. According to our inventive teachings, changing the degree of modulation can be realized by varying the amplitude of the RF signal relative to the DC bias, the modulation frequency is tunable by adjusting the LC parameters, and the linearity and duty cycle can be optimized by selecting the RF waveform. As will become clearer from the following descriptions, our invention is advantageous to adjustable degree of modulation, frequency, linearity and duty cycle in order to meet different requirements for various applications.

As shown in FIG. 3B, wavelength sweeping that covers multiple longitudinal modes of the slave oscillator can be achieved by a seeder drive current, which periodically passes through the threshold Iₜₕ for repeated on-off operation. Since each fresh start of the seeder normally takes place in different modes, the central wavelength of each sweeping spectrum jumps around, over one or more mode intervals, leading to a broadband time average so that a number of longitudinal modes of the slave oscillator are covered.

As the degree of modulation decreases, the ratio of laser-on time to laser-off time increases. When M_{d} drops below zero, the seeder operates in a CW or quasi-CW mode. Further reducing the degree of modulation causes the wavelength sweeping spectrum of the seeder narrowing, and eventually reaches to such a level that only one or few longitudinal mode(s) of the slave oscillator are covered. If the wavelength sweeping range is narrower than the mode interval, but is wider than the mode uncertainty induced by random variation of the cavity length due to fluctuations in temperature, vibration, and/or other perturbations, single longitudinal mode laser output can be obtained without implementation of the complicated cavity length control and mode selection mechanisms. Moreover, it is possible to achieve stable high-power laser operation of long coherence length. FIG. 3C graphically shows the relationship between the seeder drive current and the time-averaged seeder wavelength sweeping spectrum relative to the longitudinal modes of the slave.

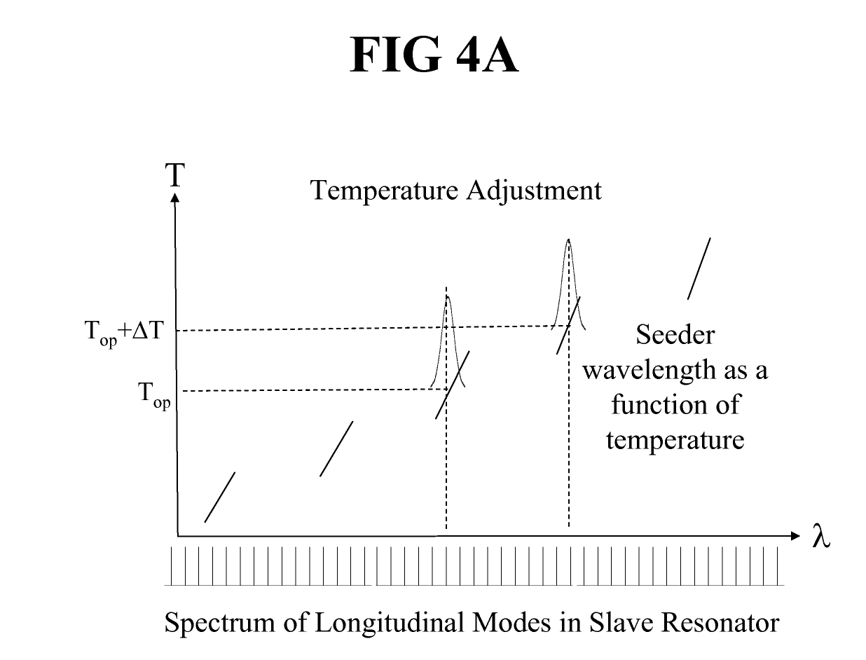

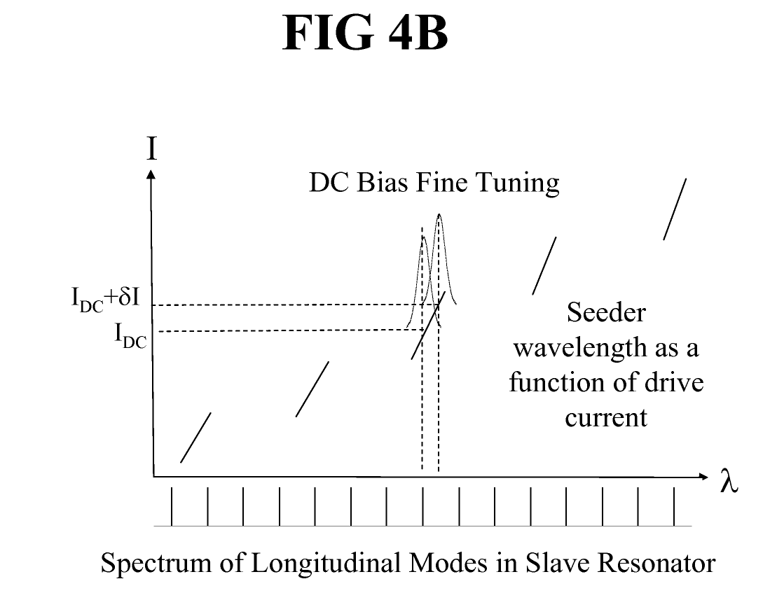

FIG. 4A shows temperature dependence of the seeder wavelength sweeping spectrum. By adjusting the operation temperature, the wavelength sweeping spectrum can move around and match any one or more longitudinal modes of the slave oscillator, as desired. For example, 0.1 K temperature change will cause 2.8 GHz frequency shift of a typical AlGaAs laser. Adjusting the operation temperature of a laser diode can be accomplished by, e.g., a thermoelectric controller (TEC).

Similarly, the seeder wavelength sweeping spectrum can be fine tuned to meet optimal working conditions, which is particularly important for stable SLM injection seeding. As shown in FIG. 4B, by fine tuning the DC bias of the drive current, the center of the seeder wavelength sweeping spectrum can be set in close vicinity of the desired longitudinal mode of the slave oscillator. Consequently, the master-slave resonance can be reached as long as the fluctuation of the slave longitudinal mode is less than the half width of the seeder wavelength sweeping spectrum. For typical AlGaAs laser diode, 1 mA current change results in approximately 2.8 GHz frequency shift.

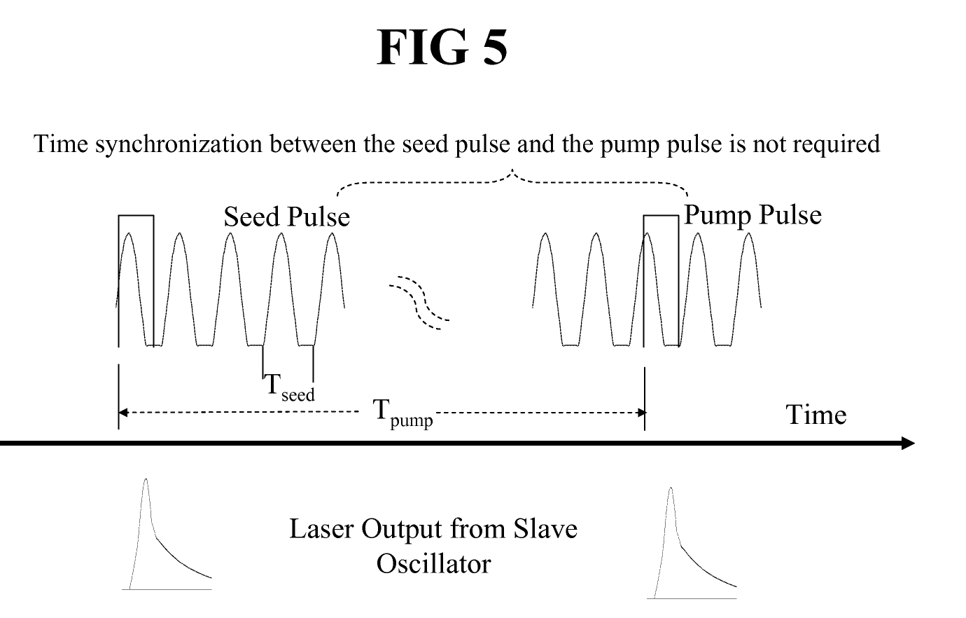

Temporal overlap between the injected seeds and the gain profile of the slave can be satisfied without precise timing synchronization, provided that the seeder operates in CW or quasi-CW mode or the interval between two successive seed pulses is narrower than the duration of the pump pulse. According to the present invention, this condition can be met in most cases, because the RF modulated laser drive current produces seeding photons, which are CW or quasi-CW or pulsed with high repetition rate, in the order of a few tens to a few hundreds MHz. Displayed in FIG. 5 are waveforms of the injection seeding and pump pulses in time domain. For seed pulses with high repetition rates and/or high duty cycles, as shown in this FIG. 5, the leading edge of any pump pulse, at least in part, is guaranteed to fall into the seed waveform so that gain is built up only with seeded modes. Timing synchronization is not required in these cases. Also shown in this graph is temporal shape of laser output from the slave oscillator. With injection seeding, the pulse buildup time is shortened. On the other hand, the pulse tail is a function of the cavity lifetime, which decreases as the cavity length shortens. For short cavity slave oscillators, a narrow pulse width can be achieved. It should be understood by those skilled in the art that our inventive teachings can also be applied to injection seeding systems with highly-repetitive or CW pump. Here again, time synchronization between the seeder and the seeded laser is not required.

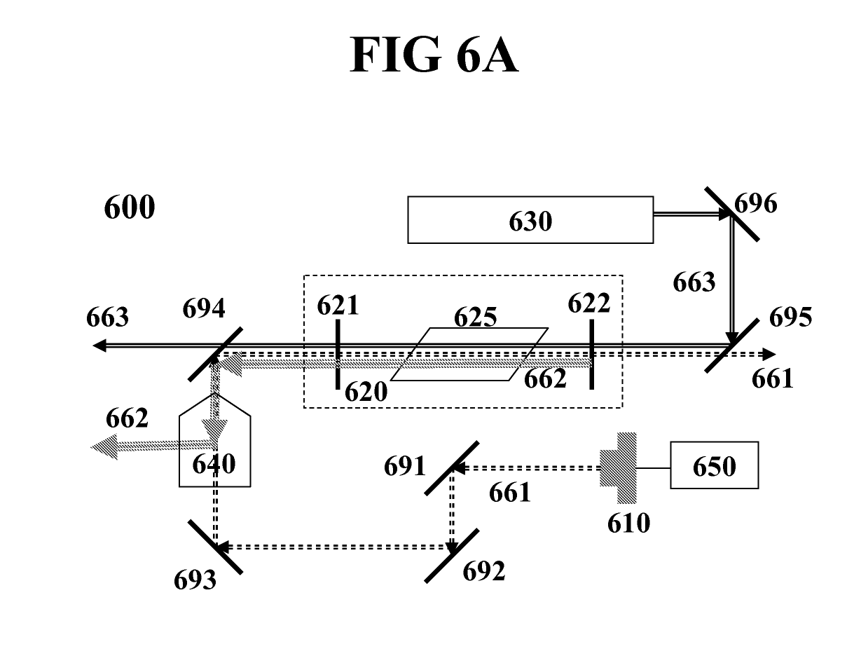

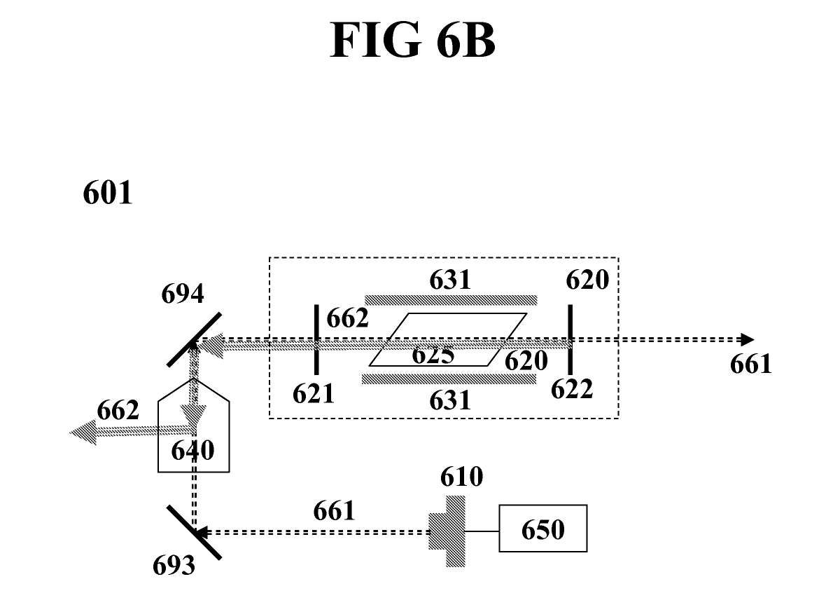

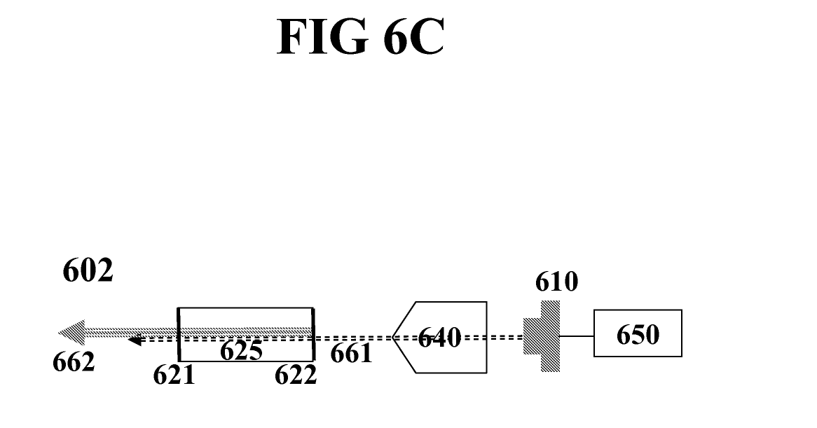

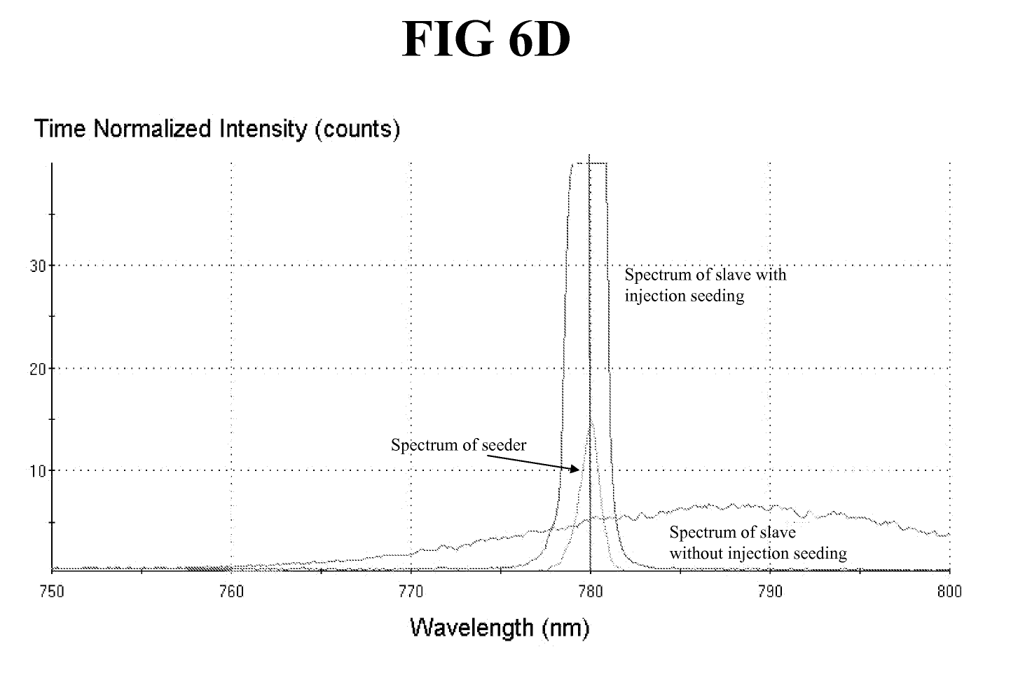

As can be appreciated by those skilled in the art, our inventive teachings are of particular merit for seeding tunable, solid-state lasers such as Ti:Sapphire or Alexandrite laser, which has a broad gain bandwidth and tuning range. As shown in FIG. 6A, a master-slave laser system 600 comprises a seeder 610 energized by drive circuit 650, a gain medium 625 placed between a pair of mirrors 621 and 622, an optical pump source 630, and an isolator 640, which can be a combination of a Faraday rotator and a polarizer for optically isolating the seeder from the slave oscillator. Advantageously, the isolator 640 can be free-space isolator(s) or fiber optic isolator(s).

In particular, the gain medium 625 can be Ti:Sipphire crystal or the like, which, together with a short or long Fabry-Perot cavity composed of the mirrors 621 and 622, form a slave oscillator 620. With a short cavity, the pulse tail is shortened, which enables producing extremely narrow pulses. Challenges for short cavity and short pump pulse operations include TEM₀₀ mode control, wavelength and spectral bandwidth control, and timing jitter or pulse repetition frequency variation caused by random fluctuation in the effective cavity length. These issues are addressed in the present invention and, in particular, are discussed in details on the basis of the exemplary configuration shown in FIG. 6A.

As is well known, Titanium Sapphire crystals possess a broad vibronic fluorescence band, which allows tunable laser output between 670-1070 nm, with the peak of the gain curve around 790 nm. In addition, this material exhibits a broad absorption band, located in the blue-green region of the visible spectrum and peaked around 490 nm. Accordingly, the pump source 630 displayed in FIG. 6A can be a frequency doubled Nd:YAG or Nd:YLF laser or other light sources such as Argon ion lasers operated at visible lines. Titanium Sapphire lasers are typically operated in gain-switched pulse mode because of the short fluorescence lifetime, around 3.2 μs at the room temperature, which results in a high threshold. Accordingly, the pump source 630 also operates in a pulsed mode, preferably has a pulse width significantly shorter than the fluorescence lifetime of the gain medium.

On the other hand, the seeder 610, which, in this particular system, is a laser diode emitting light around 780 nm and is modulated by a sine wave with radio frequency, optically seeds the Ti:sapphire laser. Due to the RF modulation, the seeder injects a series of photons 661 with wavelengths continuously sweeping over a range covering one or more longitudinal modes of the slave oscillator 620. Upon arrival of the pump pulse 663, lasing 662 is rapidly built up in the mode(s) that match the injected photons.

An alternative configuration is schematically illustrated in FIG. 6B, which is different from the configuration shown in FIG. 6A by replacing the pump laser 630 with a pump assembly 631. The pump assembly 631 comprises a light source, which can be LED arrays or VCSEL arrays or laser diode arrays or flash lamps or arc lamps or other light sources matching the absorption spectrum of the gain medium 625, and, preferably, a diffusion chamber for efficient and uniform injection of the pump energy into the gain medium. When LED arrays or VCSEL arrays are used as the pump light source, the injection-seeded laser oscillator can be operated at high repetition rates. In the configurations shown in FIG. 6A and FIG. 6B, the seeds are injected into the gain medium 625 through the front mirror 621 (output coupler). This is, however, not a necessary condition. In fact, the seeds can also be injected into the gain medium through the back mirror 622 with high reflectivity.

According to our inventive teachings, active control of the slave cavity length is not necessary. This makes great simplification of the slave oscillator possible. An exemplary configuration of a simplified slave oscillator is schematically shown in FIG. 6C, wherein the two cavity mirrors 621 and 622 are directly coated onto the gain medium 625 to form a monolithic structure, no additional intracavity elements and/or moving parts are contained. Advantageously, the gain medium 625 can be optically activated by end pumping or side pumping. In the side-pump configuration, the pump assembly is composed of a light source, which, depending on the absorption spectrum of the gain medium 625, can be LED arrays or VCSEL arrays or laser diode arrays or flash lamps or arc lamps or other devices emitting light beams of desired wavelengths, and a diffusion chamber for efficient and uniform injection of the pump energy into the gain medium. In this particular configuration, the seeds are injected into the gain medium 625 through the back mirror 622 (high reflection). This is, however, not a necessary condition. The seeds can also be injected into 625 through the front mirror 621.

Laser output of nanosecond pulse width with stable TEM₀₀ mode can be obtained in an ultra short cavity. A challenge to laser pulses in the nanosecond regime is achievement of Fourier transform limited linewidth. With the implementation of the present invention, high beam-quality laser output of nanosecond pulse width and sub-nanometer bandwidth can be achieved in an efficient and cost-effective manner. FIG. 6D compares the laser output spectra for a Ti:Sapphire laser with or without injection seeding. When injection seeding is applied, the seeder is electrically activated by an RF modulated drive current. In this particular application, the degree of RF modulation is not deep enough to completely turn off the laser operation, so that the seeds are stable quasi-CW or CW. Time synchronization between the seed laser 610 and the pump source 630 is again not required. As evidenced by referring to FIG. 6D, the injection seeding according to the present invention, although without complex cavity length stabilization, phase locking, and timing synchronization, is effective and indeed purifies the laser output spectrum. As a further advantage of the present invention, the purified spectrum can be stabilized at different laser wavelengths and the linewidth can vary, depending on the selective operation parameters, to meet the requirements and preference of various applications.

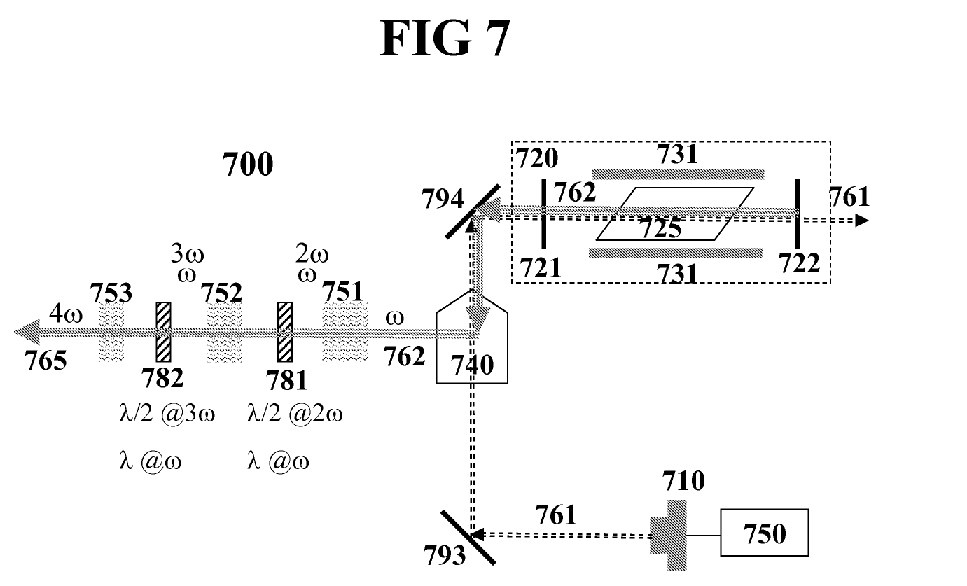

Moreover, by introducing one or more nonlinear optical crystal(s) for frequency doubling and/or sum frequency mixing, it is possible to produce UV or DUV radiation from the injection-seeded laser system. FIG. 7 shows an exemplary system constructed according to our inventive teachings. As illustrated in this graph, three nonlinear optical crystals 751, 752, and 753, which can be BBO or the like, are for frequency conversions. In this particular example, the nonlinear optical process in 751 is second harmonic generation (SHG), λ₁=λ/2, where λ is the wavelength that matches the injection-seeded laser output 762, while in crystals 752 and 753, sum frequency generations (SFG) take place, respectively, λ₂=λλ₁/(λ+λ₁), and λ₃=λ₂/(λ+λ₂). Two wave plates 781 and 782 are inserted between the nonlinear crystals for rotating the polarization states to meet the phase matching requirements. For a seeder with wavelength λ=772 nm, the laser output 765 has a wavelength of λ₃=193 nm, which can be a replacement of ArF excimer laser. The isolator 740 is used for preventing seeder 710 from interference/damage due to the feedback from slave laser 720.

It should be pointed out that the slave lasers depicted in FIGS. 6A, 6B, 6C, and 7 are not limited to Ti:Sapphire lasers. Various solid-state lasing gain media including, but not limited to, crystals with broadband emission spectra such as Alexandrite and Cr:LiSAF or other chromium-doped gain media, as well as other host materials doped with active ions such as rare earth ions, actinide ions, and transition metals, in free-running slave cavities of length from ultra short to long, can be effectively injection-seeded by employing our inventive wavelength sweeping scheme. Moreover, selection of operation modes (CW or quasi-CW or pulsed mode, SLM or multimode, with or without Q-switch) is a matter of engineering design.

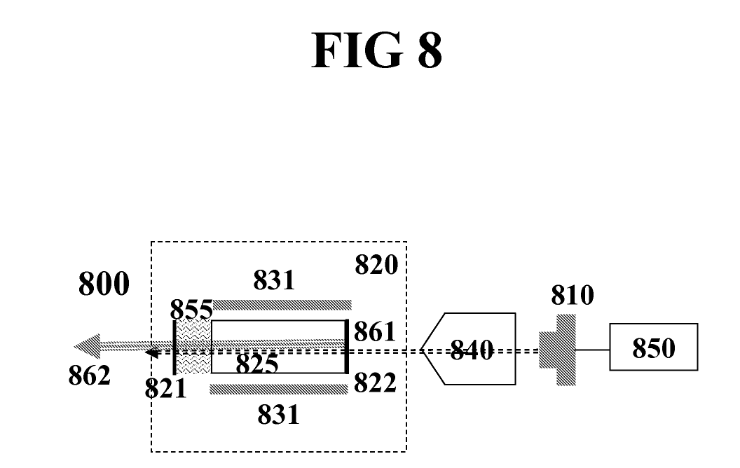

According to our inventive teachings, active control of the cavity length of the slave oscillator is not necessary, which paves the way to make very compact injection seeding systems. As shown in FIG. 8, one or more nonlinear optical crystal(s) 855 can be optically bonded onto the slave gain medium 825 for intracavity frequency conversion. Advantageously, the cavity mirrors 821 and 822, respectively, can be partially-reflective and highly-reflective coatings on the external surfaces of the monolithic microchip. With proper coatings, dual-color laser output can also be obtained. Again, the slave gain medium 825 can be end-pumped or side-pumped. In the latter case, the pump light source is advantageously LED arrays or VCSEL arrays or flash lamps or other devices emitting light beams with wavelengths that match the absorption spectrum of the gain medium, and a diffusion chamber is preferably employed. The nonlinear optical processes in 855 can be SHG, or OPO, or SFM, or difference frequency mixing, or a combination thereof, depending on the phase-matching conditions. In OPO operations, two individual seeders can be used for respectively controlling the wavelengths of the pump beam and the signal or idler beam. With optical parametric oscillation and/or difference frequency mixing, the laser output at IR wavelengths including the eye-safe range can be achieved.

Advantageously, our inventive teachings can also be applied to folded resonators or ring resonators. Folded resonators are often used for lasers with long cavity length and small beam waist. Ring lasers become attractive because they offer a way to eliminate spatial hole burning caused by the standing-wave distribution of the intensity in a conventional oscillator. Oblique angles of incidence are generally involved in such resonators, which may introduce astigmatism. Astigmatic compensation can be achieved by incorporating a laser rod that has two parallel surfaces in the focal region of the folding mirror oriented at the Brewster angle. These ring slave resonators can be planar or non-planar, unidirectional or bi-directional, monolithic or non-monolithic.

Ring cavities have separate and independent resonances in the two counter-propagating directions. When a ring resonator is injection-seeded, there is little or no optical feedback from the high-power slave into the low-power master. This attribute improves the laser stability and reduces the requirements for optical isolators. With proper design, ring lasers can be made unidirectional. Other advantages of ring resonators include increase of cavity design flexibility and alignment insensitivity. In particular, the resonator can be formed by three mirrors, or a prism and a pair of mirrors, or a pair of mirrors together with one or more Brewster-angle laser rod(s), or four mirrors together with two or more Brewster-angle laser rod(s), to mention a few. The laser rod(s) can be end-pumped or side-pumped. In the end-pumped configuration, each laser rod can be individually pumped by one or more laser diode(s), together with a means for cascaded coupling. In the side-pumped configuration, one or more diffusion chamber(s) can be incorporated for efficient and uniform pumping. When two laser rods are used, a preferred configuration is based on a double-elliptical diffusion chamber, in which the pump source is centered and the two laser rods are located at the focal points of the ellipsis. With this configuration, the laser efficiency and output power can be improved.

It should be appreciated by those skilled in art that the present invention can be applied to many other systems with various configurations. Examples of these systems include, but not limited to, master oscillator power amplifier (MOPA) or frequency-stabilized MOPA, fiber lasers, fiber amplifiers, or fiber MOPA, with or without subsequent nonlinear frequency conversions, Q-switched laser systems, optical parametric oscillation (OPO) systems, and Raman lasers. In addition, the slave laser gain medium can be solid-state, liquid, or gas.

What is claimed is:

1. A method for effective injection seeding based on continuous wavelength sweeping for master-slave resonance, wherein:
said wavelength sweeping covers one or more longitudinal mode(s) of the slave oscillator;
said wavelength sweeping is achieved through rapidly varying laser drive current;
rapidly varying laser drive current is resulted from radio frequency modulation;
said wavelength sweeping is a radio frequency process, which results in stable and low noise laser output upon time averaging;
active cavity length control and phase locking are not needed for matching the injected seeds with longitudinal modes of the slave laser;
the longitudinal modes of the slave oscillator can vary randomly as the cavity length fluctuates;
injection seeding can be in single longitudinal mode or multimode;
synchronization between the injected seeds and the time of trigging the slave laser is generally not required.
resonance between the seeder and the seeded slave is guaranteed in every pulses of slave laser generation.

2. A method as of claim 1 is adaptable for short cavity slave lasers for producing low noise laser pulses with nanosecond pulse width, TEM₀₀ beam profile, large beam size, Fourier-transform limited bandwidth, and high power in a cost effective manner.

3. A method as of claim 1 comprises steps of:
generating a pump energy flow from a pump source to activate the slave gain medium;
generating radio frequency modulated laser drive current with optimized degree of modulation, frequency, linearity and duty cycle in accordance with particular applications;
controlling seeder with said radio frequency modulated laser drive current for producing continuous wavelength sweeping;
injecting the seeds having rapidly swept wavelength, through free space or fiber coupling, into the slave oscillator with spatial overlap;
building up laser oscillation in the slave oscillator in the modes matching the injected seeds;
wherein:
pump source can be electrical or optical, continuous or pulsed;
for continuous-pump or for pulsed-pump where the interval between two successive seeding processes is short than the pump pulse duration, time synchronization between the seed and the pump is not required;
this condition can always be met by adjusting the modulation frequency and the degree of modulation.

4. A method as of claim 1 wherein:
single longitudinal mode laser output is produced if:
the sweeping spectrum covers one and only one longitudinal mode of the slave laser;
the central wavelength of the sweeping spectrum is tuned to match the desired longitudinal mode;
tuning the central wavelength of the sweeping spectrum to match the desired single longitudinal mode is a one-time process;
said tuning can be accomplished by adjusting the temperature and/or drive current of the seeder;
the desired longitudinal mode fluctuates within the bandwidth of the sweeping spectrum; and
long coherence length can be achieved in single longitudinal mode operation.

5. A method as of claim 1 wherein:
multiple longitudinal mode laser output is produced if:
the sweeping spectrum is broadband, covering at least two longitudinal modes of the slave oscillator;
the central wavelength of the sweeping spectrum is tuned in vicinity of the average wavelength of the desired longitudinal modes;
tuning the central wavelength of the sweeping spectrum to match the average wavelength of the desired longitudinal modes is a one-time process;
said tuning can be accomplished by adjusting the temperature and/or drive current of the seeder;
the average wavelength of the desired longitudinal modes fluctuates within the bandwidth of the sweeping spectrum;
from pulse to pulse, the resonance between the seeder and the seeded slave persists though may occur in different longitudinal modes upon fluctuations of cavity length.

6. A method as of claim 1 wherein said radio frequency modulated drive current is featured with:
adjustable degree of modulation and frequency for optimized performance and to meet the requirements of various applications.

7. An injection-seeding laser system constructed in accordance with the inventive method described in claim 1 comprises:
a laser diode as the seeder;
a slave laser, further consisting of one or more gain media and an optical resonator cavity;
coupling between the seeder and the slave laser can be free space or optic fiber;
a pump source for exciting said gain media;
one or more isolator(s) for isolating the seeder from slave laser output;
optical elements for spatial overlap between the injected seeds and the slave cavity modes; and
other elements/components optional according to specific applications;
wherein:
said laser diode is energized by a radio frequency modulated drive current to produce stable laser output, featured with continuous wavelength sweeping;
said radio frequency modulated drive current is generated by a circuit composed of a DC generator to generate DC bias, an RF generator to generate RF signal, and a summing junction for superimposing the DC bias and the RF signal;
said pump source may be electrical or optical, operated in continuous or pulsed mode with various pulse widths and repetition rates;
said optical resonator cavity of the slave oscillator consists of at least two mirrors for laser resonant oscillation and for output coupling;
said gain medium is placed within said resonator cavity;
synchronizer for timing the injection seeding and the slave laser triggering is generally not required because the RF modulated injection seeding is CW or quasi-CW or pulsed with highly (RF) repetitive rates, which provides for satisfactory temporal overlap between the injected seeds and creation of the population inversion in the slave gain medium;
the slave gain medium may be solid-state, or liquid (dye), or gas including excimer.

8. An injection-seeding laser system as of claim 7, wherein:
the slave gain medium is solid-state;
the gain medium is activated by optical pumping;
optical pumping can be CW or pulsed;
the pump source emits light that matches the absorption spectrum of said gain medium;
said pump source provides for end-pump or side-pump;
side-pump can be enhanced by one or more diffusion chamber(s);
the pump light source can be one or more laser diode(s), or diode arrays, or diode pumped solid-state lasers with or without wavelength conversion, or LED arrays, or VCSEL arrays, or flash lamps, or arc lamps.

9. An injection-seeding laser system as of claim 7, wherein:
the DC bias is controlled by an automatic power or current control system based on feedback signal;
the RF signal can be a sine wave, a rectified sine wave, a distorted sine wave, or other periodic waves, preferably linear or quasi-linear piecewise and having a duty cycle of 50% or greater;
the bandwidth of seeder wavelength sweeping is determined by the degree or depth of RF modulation, which is variable by adjusting the amplitude of the RF signal relative to the DC bias;
the repetition rate of seeder wavelength sweeping is variable by adjusting the frequency of RF modulation;
the uniformity of seeder wavelength sweeping is optimized by appropriate selection of the RF waveform, which determines the linearity and duty cycle of RF modulation.

10. An injection-seeding laser system as of claim 7, wherein:
said pump source produces pump pulses, preferably with the pulse duration considerably shorter than the fluorescence lifetime of the slave gain medium for gain switching;
temporal overlap between the pump pulse and the seed pulse can be achieved without timing synchronization if the injection seeding is CW or quasi-CW or pulsed with repetition rate higher than a few tens MHz.

11. An injection-seeding laser system as of claim 8, wherein:
optical pump is provided by LED or VCSEL arrays for injection seeding of high repetition rates.

12. An injection-seeding laser system as of claim 7, wherein:
said resonator has a linear cavity, or a folded cavity, or a composite cavity, or a ring cavity with or without astigmatic compensation;
a linear cavity is composed of two mirrors, which can be physically separated from the lasing gain medium or be directly coated/mounted onto the lasing gain medium to form a monolithic structure;
a ring cavity can be planar or non-planar, unidirectional or bi-directional, monolithic or non-monolithic;
one or more gain media can be placed in a ring resonator for output power/efficiency improvement;
a preferable configuration of ring resonator comprises two or more laser gain media that are side-pumped with enhancement of multi-elliptical diffusion chamber;
another preferable configuration of ring resonator comprises two or more laser gain media that are end-pumped by a number of laser diodes together with a means for cascade coupling.

13. An injection-seeding laser system as of claim 8, wherein:
said resonator cavity is short in length and composed of two plane-parallel mirrors as an ordinary Fabry-Perot resonator;
these two mirrors can be physically separated from the lasing gain medium or be directly coated onto the lasing gain medium to form a monolithic structure.

14. An injection-seeding laser system as of claim 7, wherein:
one or more nonlinear optical device(s) can be incorporated for wavelength conversion to produce UV, visible, IR, or other wavelengths.

15. An injection-seeding laser system as of claim 8, wherein:
one or more nonlinear optical crystal(s) can be incorporated for intracavity or extracavity frequency conversion;
these nonlinear optical crystal(s) are optically bonded onto the gain medium of the slave laser to form a monolithic microchip;
cavity mirrors are directly coated onto the external surfaces of the monolithic microchip.

16. An injection-seeding laser system as of claim 8, wherein:
said gain medium can be selected from solid-state laser materials including oxides, phosphates, silicates, tungstates, molybdates, vanadates, beryllates, fluorides, glasses, and ceramics, doped with active ions including rare earth ions, actinide ions, transition metals; such as
vibronic materials including Titanium Sapphire, Alexandrite, Chromium doped LISAF, and similar; for
spectral purification and stabilization at various wavelength with desired bandwidth suitable for different applications; and
continuous tunability.

17. An application of radio frequency modulated laser diode:
as a light source for non-invasive injection seeding,
which eliminates the needs for any modification to the slave laser,
which eliminates the needs for phase locking between the injected and output signals,
which eliminates the needs for time synchronization between the injection seeding and the triggering signal to the slave,
based on continuous wavelength sweeping for matching the injected seeds with one or more longitudinal mode(s) of the slave oscillator in every pulse in a reliable and cost-effective manner;
applicable to any slave gain media and any cavity configurations;
applicable to any wavelengths, any spectral and temporal modes.

18. An application as of claim 17, wherein:
said laser diode produces continuous wavelength sweeping having a narrow bandwidth, covering one and only one longitudinal mode of the slave;
injection seeding is in single longitudinal mode; and
applicable to systems requiring narrowband spectrum and long coherence length.

19. An application as of claim 17, wherein:
said laser diode produces continuous wavelength sweeping having a broad bandwidth, covering at least two longitudinal modes of the slave;
injection seeding is in multiple longitudinal mode; and
applicable to systems requiring broadband spectrum, low coherence, and low speckle.

20. An application as of claim 17, wherein:
the injection seeding is for an ordinary optical oscillator, or a fiber laser, or a regenerative amplifier, or an optical parametric oscillator, or a Raman laser, or any other systems requiring wavelength/spectrum control.
